(19) United States
(12) Patent Application Publication
(10) Pub. No.: US 2019/0026674 A1
(43) Pub. Date: Jan. 24, 2019

(54) SMART ROUTING FOR COMMUNICATION SERVICES

(71) Applicant: T-Mobile USA, Inc., Bellevue, WA (US)

(72) Inventors: Angela Joslin, Bellevue, WA (US); Callie Field, Bellevue, WA (US); Charles Lamb, Bellevue, WA (US); Mikael Weigelt, Seattle, WA (US); Clayton Tredway, Bellevue, WA (US); Joseph Preston, Bellevue, WA (US); Jeremy Harris, Bellevue, WA (US); John Consalvo, Bellevue, WA (US); Michael Carley, Bellevue, WA (US); Kien Chim, Renton, WA (US); Brian Alleman, Bellevue, WA (US); Philip Ludwig, Kirkland, WA (US); Vikash Kodati, Issaquah, WA (US); Sameer Parashar, Bellevue, WA (US)

(21) Appl. No.: 16/039,252

(22) Filed: Jul. 18, 2018

Related U.S. Application Data
(60) Provisional application No. 62/534,142, filed on Jul. 18, 2017.

(51) Int. Cl. G06Q 10/06; G06Q 40/00; G06T 11/20; G06F 3/0482

(52) U.S. Cl. CPC G06Q 10/06393; G06Q 40/12; G06Q 10/06398; G06F 3/0482; G06T 11/206

(57) ABSTRACT

Techniques for evaluating the performance and effectiveness of user support services and capital resources are disclosed herein. One or more tools are provided that allow a user support services group to be managed more efficiently. User support services groups are managed as a typical profit and loss (P&L) center, and one or more tools provides a P&L-type interface that allows user services support managers to make balancing decision taking into account revenue and cost considerations.

### BACKGROUND

Enterprises often rely on continued patronage of users of their products or services. One way that such enterprises ensure continued patronage is to provide resources for user support so that users have access to quality user support services. Quality user support services typically aim to achieve one or more of several goals. For example, one goal is to make it easy for users to connect with user support representatives by scheduling an appointment using a convenient application, or by calling or messaging user support representatives that are readily available. Another quality goal for user support services is to minimize call transfers, thereby enabling a user support representative to have complete ownership of an issue, and to provide a better experience for a user by, for example, not having to repeat themselves as they are transferred from one representative to another. Additionally, a goal may be to provide solutions as quickly as possible by having a team of experts that persist institutional knowledge.

Of course, enterprises must balance the resources provided to user support services with capital means available. Better management of user support services and capital enables enterprises to devote maximum resources to user support services which, in turn, satisfies and retains users and, eventually contributes to the bottom line of an enterprise. Having the ability to evaluate the performance and effectiveness of different user support service resources and techniques is a large part of increasing the quality of management of user support services and capital.

### BRIEF DESCRIPTION OF THE DRAWINGS

The detailed description is described with reference to the accompanying figures, in which the left-most digit(s) of a reference number identifies the figure in which the reference number first appears. The use of the same reference numbers in different figures indicates similar or identical items.

FIG. 1 is a diagram of an example user support services system in which the technological solutions described herein may be implemented.

FIG. 2 is a diagram of an example computing device in accordance with the technologies described herein.

FIG. 3 is a diagram of an example profitability overview user interface template for use in one or more tools as described herein.

FIG. 4 is a diagram of an example profitability overview user interface as used in one or more tools described herein.

FIG. 5 is a diagram of an example scenario analysis user interface template for use in one or more tools described herein.

FIG. 6A is a diagram of an example scenario analysis user interface as used in one or more tools described herein.

FIG. 6B is a diagram of an example updated scenario analysis user interface as used in one or more tools described herein.

FIG. 7 is a diagram of an example metric trends user interface template as used in one or more tools described herein.

FIG. 8 is a diagram of an example metric trends user interface as used in one or more tools described herein.

FIG. 9 is a flow diagram of an example methodological implementation for a scenario analysis as used in one or more tools described herein.

### DETAILED DESCRIPTION

### Overview

Techniques for evaluating the performance and effectiveness of user support services and capital resources are disclosed herein. Performance metrics are utilized to heighten awareness of the characteristics most import to users and to an enterprise. Sharing of performance metrics between user support services groups provides goals and incentives for improving user support services, overall as well as in a particular group. Maintaining control of user support calls by a user support services group in a similar geographic location of a user provides a common knowledge between a user and a user support services representative, thus increasing a user's satisfaction. Likewise, directing user contacts to representatives having expertise with the issue at hand provides less frustration for a user and leads to a more efficient resolution.

One or more tools are provided that allow a user support services group to be managed more efficiently. User support services groups are managed as a typical profit and loss (P&L) center, and one or more tools provides a P&L-type interface that allows user services support managers to make balancing decision taking into account revenue and cost considerations. The use of such a P&L-type tool also provides enhanced visibility and insight by combining numerous measures into a single user interface for rapid and flexible visibility and ad hoc analysis. Additionally, use of such a P&L-type tool helps to foster accountability and collaboration by allowing managers to be better informed of performance and opportunities for individual and relative improvement to other teams according to selected performance metrics.

For example, in at least one implementation described herein, a profitability over time metric provided by a profitability tool indicates a customer care team's incremental profit over time, team performance vs. other teams, as well as show trends in one or more profitability metrics. The metric trends are comparable across multiple teams, and the trends can provide an overall context such as company-wide trends and company-wide averages. The metric trends may be presented to a user in multiple perspectives, such as by raw totals and difference from a specified target. A scenario analysis tool provides, among other things, a scenario analysis that shows how variances of specific revenue and cost items affect team performance rankings, score, and other metrics.

### EXAMPLE USER SUPPORT SERVICES SYSTEM

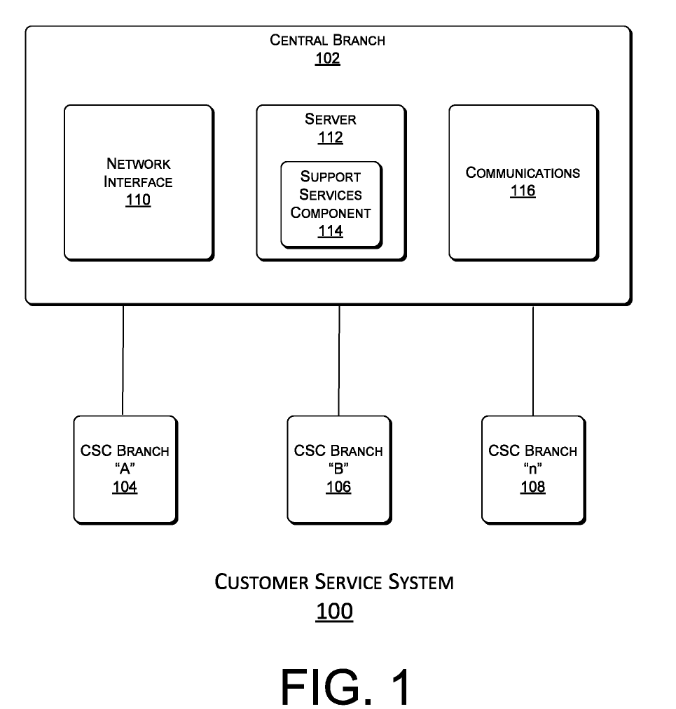

FIG. 1 is a diagram of an example user support services system 100 in which the technological solutions described herein may be implemented. FIG. 1 illustrates a user support services system 100 wherein multiple support groups, often distinguished by geographic location, are able to communicate with each other and with a central location that maintains user support services tools. Although the user support services system 100 is described as being distributed over a plurality of geographic locations, it is noted that the techniques described herein may be utilized with a single group or with multiple groups in a single location.

The example user support services system 100 includes a central branch 102 that communicates with a first remote branch (“Remote Branch A” 104), a second remote branch (“Remote Branch B” 106), and one or more other remote branches (“Remote Branch n” 108). The remote branches 104, 106, 108 can also communicate with other, either directly or via the central branch 102. The central branch 102 and the remote branches 104, 106, 108 can be separate installations in various geographical locations, separate groups within a single installation, or separate installations in a single geographical location.

The central branch 102 of the example user support services system 100 includes a network interface 110 that provides one or more interfaces with any type of network that supports electronic devices, such as one or more wireless network interfaces, one or more hard-wired interfaces (such as Ethernet), an interface with a Local Area Network (LAN), a Wide Access Network (WAN), or the like. The central branch 102 also includes a communications system 112 made up of one or more types of communication modalities, such as a telephone network system, a system of wireless telephones, a text-based communication system, and/or the like. The central branch 102 of the example user support services system 100 includes one or more servers 114 that serve applications and data to the central branch 102 and the remote branches 103, 106, 108. The server 114 includes a support services component 116 that includes the tools, applications, and user interfaces described in greater detail, below, with respect to subsequent figures.

### EXAMPLE COMPUTING DEVICE

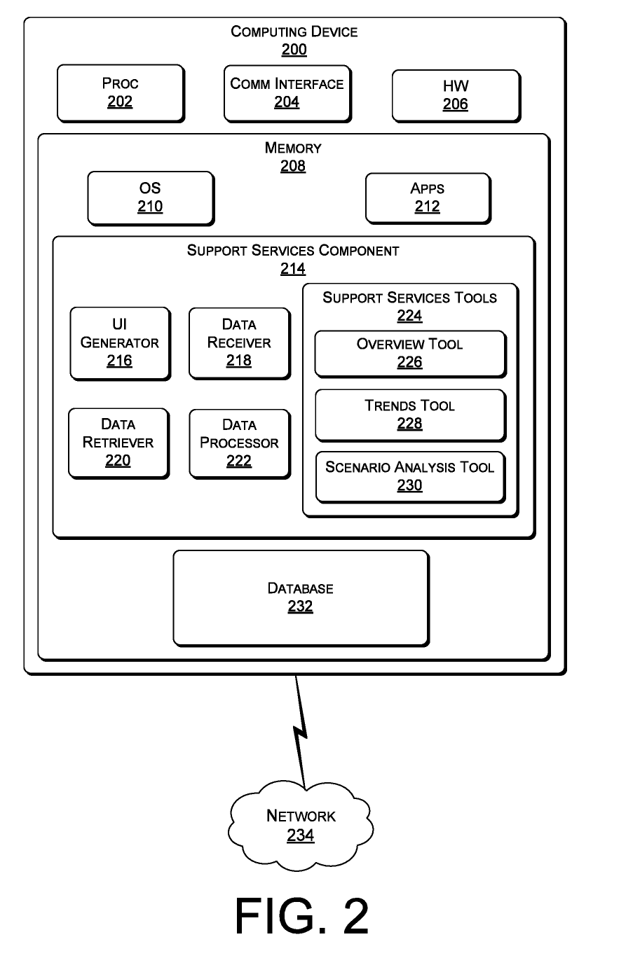

FIG. 2 is a block diagram of an example computing device 200 in accordance with the technologies described herein. The one or more servers 114 shown in FIG. 1 are examples of the example computing device 200 in an operating environment, in particular, the user support services network environment 100.

In the following discussion, certain interactions may be attributed to particular components. It is noted that in at least one alternative implementation not particularly described herein, other component interactions and communications may be provided. The following discussion of FIG. 2 merely represents a subset of all possible implementations. Furthermore, although other implementations may differ, one or more elements of the example computing device 200 are described as a software application that includes, and has components that include, code segments of processor-executable instructions. As such, certain properties attributed to a particular component in the present description, may be performed by one or more other components in an alternate implementation. An alternate attribution of properties, or functions, within the example computing device 200 is not intended to limit the scope of the techniques described herein or the claims appended hereto.

The example computing device 200 includes one or more processors 202, one or more communication interfaces 204, and miscellaneous hardware 206. Each of the one or more processors 202 may be a single-core processor or a multi-core processor. The communication interface 204 facilitates communication with components located outside the example computing device 200, and provides networking capabilities for the example computing device 200. For example, the example computing device 200, by way of the communications interface 204, may exchange data with other electronic devices (e.g., laptops, computers, other servers, etc.) via one or more networks 205, such as the Internet. Communications between the example computing device 200 and other electronic devices may utilize any sort of communication protocol known in the art for sending and receiving data and/or voice communications.

The miscellaneous hardware 206 includes hardware components and associated software and/or or firmware used to carry out device operations. Included in the miscellaneous hardware 206 are one or more user interface hardware components not shown individually—such as a keyboard, a mouse, a display, a microphone, a camera, and/or the like—that support user interaction with the example computing device 200.

The example computing device 200 also includes memory 208 that stores data, executable instructions, modules, components, data structures, etc. The memory 208 can be implemented using computer readable media. Computer-readable media includes at least two types of computer-readable media, namely computer storage media and communications media. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. Computer storage media may also be referred to as “non-transitory” media. Although, in theory, all storage media are transitory, the term “non-transitory” is used to contrast storage media from communication media, and refers to a component that can store computer-executable programs, applications, and instructions, for more than a few seconds. In contrast, communication media may embody computer readable instructions, data structures, program modules, or other data in a modulated data signal, such as a carrier wave, or other transmission mechanism. Communication media may also be referred to as “transitory” media, in which electronic data may only be stored for a brief amount of time, typically under one second.

An operating system 210 is stored in the memory 208 of the example computing device 200. The operating system 210 controls functionality of the processor 202, the communications interface 204, and the miscellaneous hardware 206. Furthermore, the operating system 210 includes components that enable the example computing device 200 to receive and transmit data via various inputs (e.g., user controls, network interfaces, and/or memory devices), as well as process data using the processor 202 to generate output. The operating system 210 can include a presentation component that controls presentation of output (e.g., display the data on an electronic display, store the data in memory, transmit the data to another electronic device, etc.). Additionally, the operating system 210 can include other components that perform various additional functions generally associated with a typical operating system. The memory 210 also stores various software applications 212, or programs, that provide or support functionality for the example computing device 200, or provide a general or specialized device user function that may or may not be related to the example computing device per se.

The memory 208 also stores a user support services component 214 that is similar to the user support services component 116 shown stored on the server(s) 114 in FIG. 1. The user support services component 214 performs and/or controls operations to carry out the techniques presented herein and includes several elements that work together to provide improved systems and tools for managing and evaluating user support services.

The user support services component 214 includes a user interface (UI) generator 216 that is configured to provide one or more user interfaces described herein, using the miscellaneous hardware 206 and communication interfaces 204 of the computing device 200. The user support services component 214 also includes a data receiver 218 and a data retriever 220. The data receiver 218 includes one or more executable code segments that, when executed by the processor 202, utilize computing device 200 components to receive data from a source external to the computing device 200. The data retriever 220 includes one or more executable code segments that, when executed by the processor 202, retrieve data stored within the computing device 200. A data processor 222 includes executable code segments that, when executed by the processor 202, perform operations on data received or retrieved by the computing device 200 to derive information that is provided via one or more user interfaces.

The user support services component 214 also includes user support services tools 224. The user support services tools 224 include, but are not limited to, an overview tool 226, a scenario analysis tool 228, and a trends tool 230. Generally, the overview tool 226 provides a view into multiple aspects of user support group profitability (i.e. revenue and costs), across one or multiple user support groups. The scenario analysis tool 228 generally allows a user to manipulate data values in “what if” scenarios and see how changes to one value affect other values. The trends tool 230 generally allows a user to view values of certain performance metrics over time. Each of the user support services tools 224 are described in greater detail, below, with respect to subsequent figures.

The computing device 200 also includes a database 232 that may be stored in the memory 208 or on memory located outside the computing device 200, such as in an external storage media hard drive or USB (Universal Serial Bus) drive, network storage media, storage media on a different computing device, etc. As shown in FIG. 2, the database 232 is stored in the memory 208 of the example computing device 200.

Additional aspects of the example computing device 200 will be set forth, below, with respect to descriptions of one or more additional figures, which may refer to the elements and reference numerals shown in FIG. 2.

### EXAMPLE PROFITABILITY OVERVIEW UI TEMPLATE

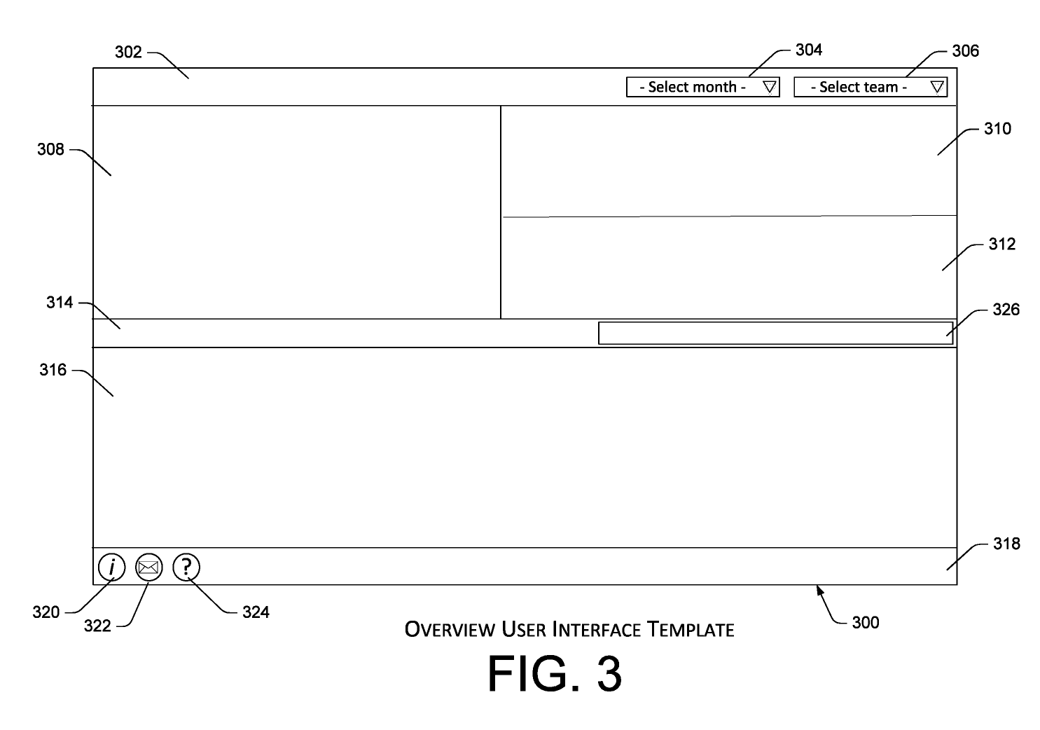

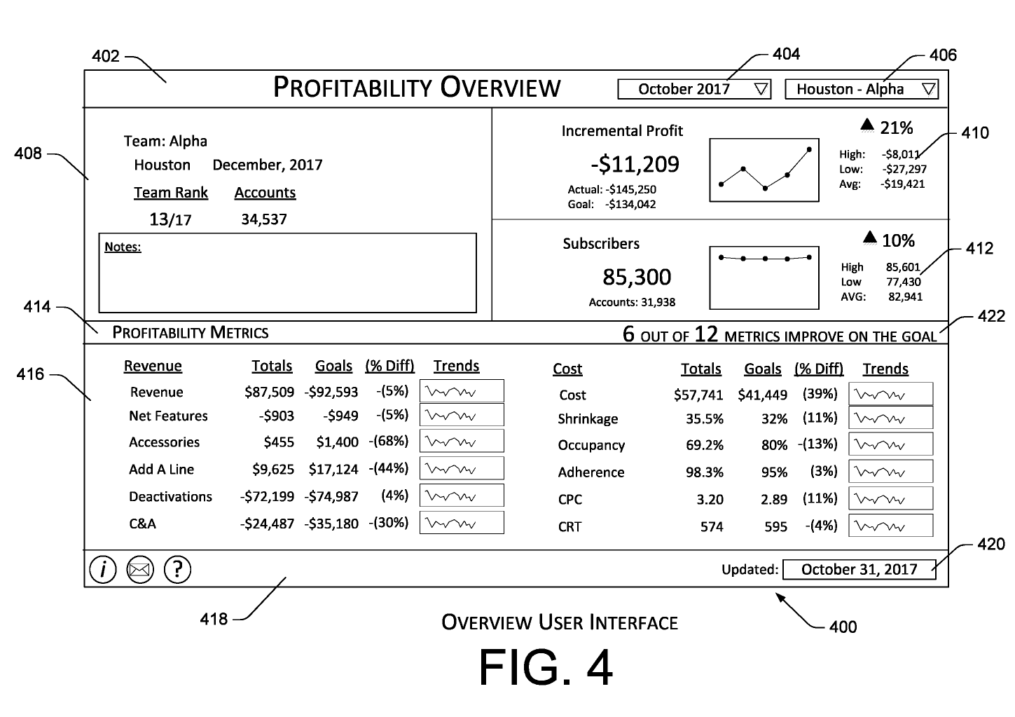

FIG. 3 is a diagram of an example profitability overview user interface template 300 for use in one or more tools as described herein. The example profitability overview user interface template 300 (hereinafter the “example user interface template”) shows generalized portions of a user interface, which may contain different types of details in different implementations, at least one of which is shown with respect to FIG. 4. However, it is noted that the arrangement of windows shown on the example template 300 is novel in itself when implemented in accordance with the present description.

The example user interface template 300 includes a title bar 302 that is used to display a title for the user interface. The title bar 302 includes a time period selector 304 and a group, or team, selector 306. The group selector 306 allows a user to select a particular user support group for analysis over a period of time, such as a particular month, selected by the user with the time period selector 306. Also included in the example user interface template 300 is a group information window 308, a subject window 310, and a customer information window 312.

The group information window 308 is reserved for provision of data related to a specific user support services group, or team. In at least one implementation, a group for which data is provided in the group information window 308 is one of the elements shown in FIG. 1—the central branch 102 (FIG. 1) or a remote branch 104, 106, 108 (FIG. 1). The group information window 308 provides a location for display of general characteristics of such a group. The subject window 310 is a location where specific data related to a primary subject for the user interface is displayed for the group shown in the group information window. In this particular example, incremental profit is a key metric that is tracked to provide improved customer support evaluation and management. Therefore, the subject window 310 contains information that relates to the incremental profit. In at least one other implementation, the subject window 310 may related to a different subject. The customer information window 312 reserves a display location for data regarding general customer information, such as a total number of customers assigned to the group designated in the group information window 308, a number of accounts held by the customers, data regarding changes to the number of customers and/or accounts, etc.

The example user interface template 300 also includes a sub-title bar 314 that may contain a sub-title that is related to a title shown in the title bar 302. A profitability metrics window 316 is included in the example user interface template 300 and is display space reserved for profitability metrics, a key metric involved in the techniques described herein. The example user interface template 300 further includes a tool bar 318 located at the bottom of the interface, which contains various icons that, when clicked, execute utilities that may assist a user. In the present example, the tool bar 318 includes an information icon 320, a message icon 322, and a help icon 324. More, fewer, and/or different icons may be included in an alternate implementation. A summary window 326 is also included in the example user interface template 300, and is reserved for a key summary data item related to the information in the profitability metrics window 316 and identified in the sub-title bar 314.

### EXAMPLE OVERVIEW USER INTERFACE

One specific example of how the example user interface 300 may be implemented is shown and described below with respect to FIG. 4, which is a diagram of an example profitability overview user interface 400 as used in one or more tools described herein. The example profitability overview user interface 400 shown but one particular implementation of how the example user interface 300 (FIG. 3) may be used. In the following discussion of FIG. 4, continuing reference is made to certain elements shown in FIG. 3.

The example profitability overview user interface 400 includes a title bar 402, a time period selector 404, and a group selector 406. The title bar 402 is shown displaying the subject of the interface, “Profitability Overview.” The time period selector 404 displays a particular month from which displayed data is drawn (“October 2017”), and the group selector 406 displays a particular user support services group to which the displayed data relates (“Houston-Alpha”), which happens to refer to a particular team located in the Houston area.

A group information window 408 displays information related to the “Houston-Alpha” team identified by the group selector 406. The information shown in the present example includes the team name, the date period identified by the time period selector 404, a number of accounts, and a team rank relative to other similar teams (i.e. user support services groups). In the implementation shown, the group information window 408 includes a space for entering user notes, which can be preserved for future viewers of information related to the “Houston-Alpha” team.

The example profitability overview user interface 400 includes a subject window 410 that shows data related to a current subject of the user interface—incremental profit. Different data related to the subject may be displayed in the subject window 410. In this particular example, the subject window 410 displays an actual profit (actual revenue minus actual costs), a profit goal (revenue goal minus cost goal), and an incremental profit, which is the difference between the actual profit and the profit goal. Other information related to the subject of incremental profit may be displayed in the form of a graph showing a history, a high value during the designated time period, a low value during the designated time period, an average value during the time period, and an increase (or decrease) in value over the time period. Additional, fewer, or other data related to the subject may be included in the subject window 410.

A customer information window 412 is also included in the example profitability overview user interface 400. Although different or other information may be included, the present implementation shows a number of subscribers and a number of accounts. Other information related to these numbers are shown in chart form and in numerical values, including a high value, a low value, an average value, and a relative change in the values compared to a previous period.

The example profitability overview user interface 400 also includes a sub-title bar 414 that, in the present example, displays a sub-title “Profitability Metrics.” The sub-title bar 414 relates to and describes information shown below the sub-title bar 414 in a profitability metrics window 416. More details regarding the information shown in the profitability metrics window 416 are provided below, following a brief discussion of other elements of the example profitability overview user interface 400.

A tool bar 418 is provided in the example profitability overview user interface 400 and serves the functions attributed to the tool bar 318 shown in FIG. 3. In the present example, an update window 420 is shown located in the tool bar 418. The update window 420 provides a time at which the data used to compute the information shown in the profitability metrics window was last updated. Finally, the example profitability overview user interface 400 also includes a summary window 422 that provides a summary of some aspect of the profitability metrics information displayed in the profitability metrics window 416. In the present example, the summary window 422 indicates that, of the twelve (12) metrics displayed, six (6) have values that are an improvement over the metrics goal. It is noted that a different aspect of the profitability metrics information may be summarized in the summary window 422.

Referring now to the information displayed in the profitability metrics window 416, it is noted that the present example relates to a cellular services provider. Therefore, certain data is specific to such an enterprise. In use cases for enterprises involved in different lines of business, revenue items will be different. In the present example, the profitability metrics window 416 displays column headings for revenue, costs, totals, goals, % difference, and trends.

Revenue items are shown in the column headed “Revenue,” and include “Revenue,” “Net Features,” “Accessories,” “Add A Line,” “Deactivations,” and “C&A.” “Net Features” is a revenue item that relates to cellular features upsold to existing customers of the cellular services enterprise. “Accessories” identify gross accessory sales to existing customers. “Add A Line” is a value associated with selling additional cellular lines to existing customers. “Deactivations” is a value associated with a number of existing customers that cancel their cellular services. “C&A” is a value related to credits and adjustments made to existing customer accounts. “Revenue” equals “Net Features” plus “Gross Accessories” plus “Add A Line” minus “Deactivations” minus “C&A.”

The information in the profitability metrics window 416 shows actual values for the line items described above, and goals for each line item. In addition, a difference (expressed as a percentage) between the actual values and the goal values is shown. In this particular implementation, a chart showing a trend over time for each of the line items is also shown. This information provides a user support representative or manager to quickly discern a current state of revenues for a particular group, and to identify any specific areas that may be excelling or lagging in performance against goals.

As shown, revenue is displayed on one side of the profitability metrics window 416, and costs are shown on the other. Under the “Cost” heading are particular cost line items, including “Cost,” “Shrinkage” (time spent by a representative online but not taking calls, e.g., in meetings, etc.), “Occupancy” (time spent online engaged in a call-related activity), “Adherence” (time spent in call-related activity during scheduled working time), “CPC” (calls per customer), and “CRT” (average time spent on calls).

The “Cost” line item is a value representing total cost, which depends on the other cost line items. The “Cost” line item is equal to “team salary” plus “overflow cost.” “Overflow Cost” is determined by the formula: “Overflow Cost=Overflow Calls*representative CRT*representative cost per second.” “Overflow Calls” is determined by the formula: “Overflow Calls=(Overflow hours*60*60)/Team Internal CRT. “Overflow Hours” is determined by the formula: “Overflow Hours=((Team Raw Staffed Hours*(1−Shrinkage)*Adherence*Occupancy))−(((CPC*Team Avg Subs*30/365)*Team CRT)/60/60.

Similar to the values for revenues, the values displayed for costs allow a user support services representative or manager to view key metrics for a user support services group and to quickly identify any problem areas or any over-performing areas. This provides a mechanism that enables managers to make trade-off decision across both revenue and cost considerations in a balanced manner. This mechanism also allows managers to be better informed of performance and opportunities for individual and relative improvement to other teams.

### EXAMPLE SCENARIO ANALYSIS UI TEMPLATE

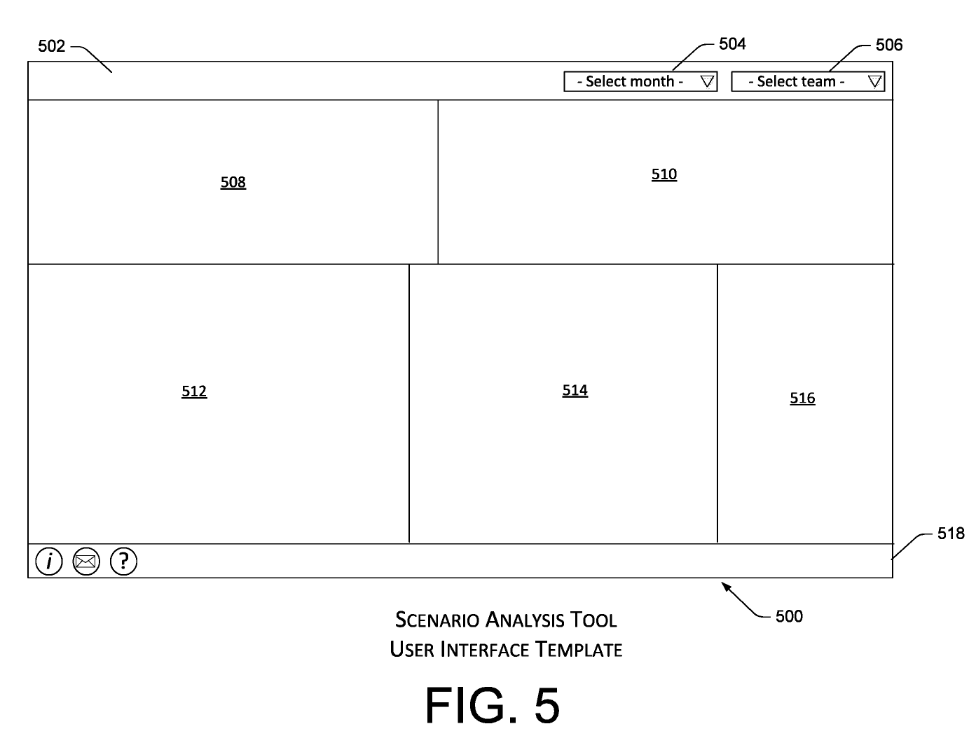

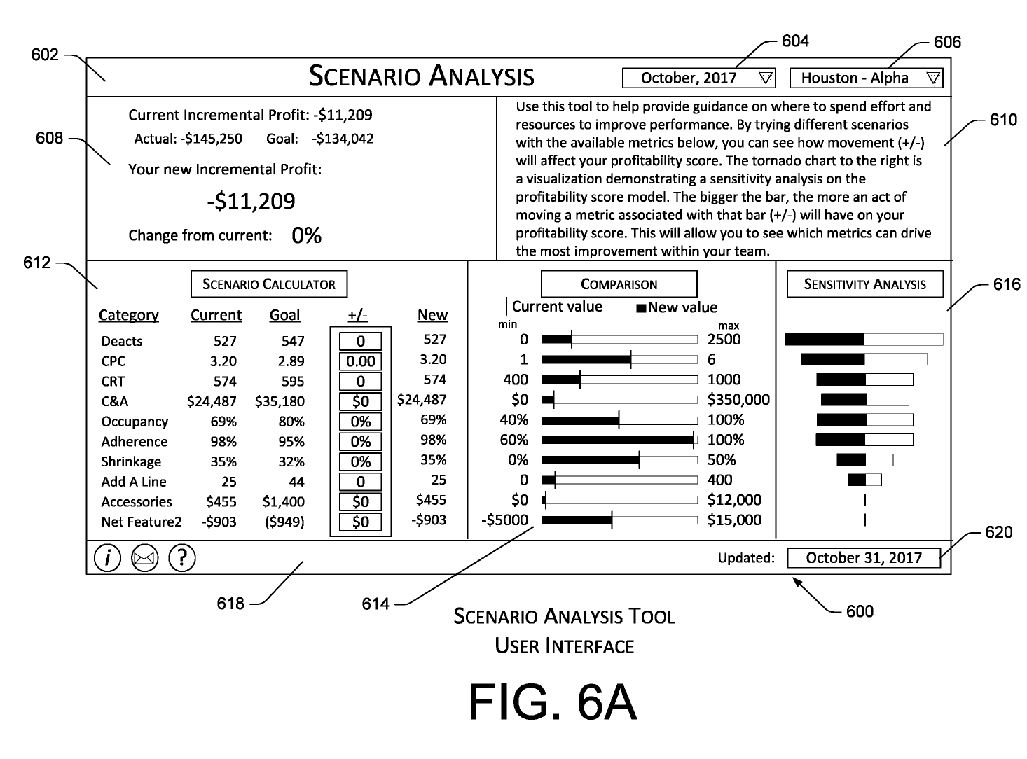

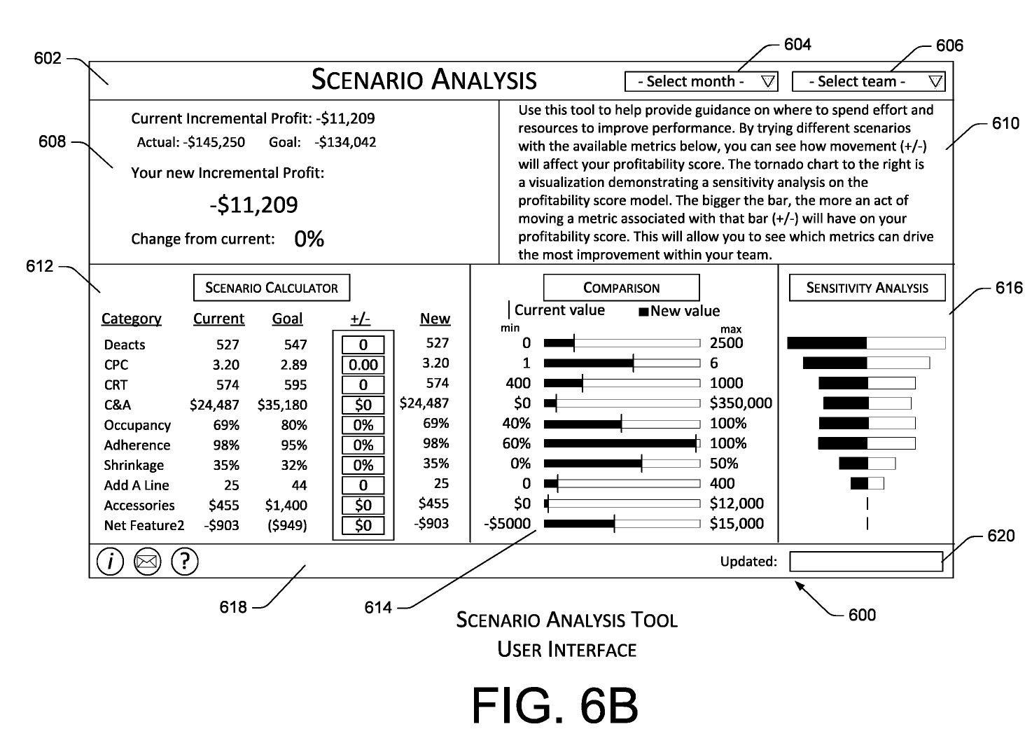

FIG. 5 is a diagram of an example scenario analysis user interface template for use in one or more tools described herein. The example scenario analysis user interface template 500 (hereinafter the “example scenario analysis template 500”) shows generalized portions of a user interface, which may contain different types of details in different implementations, at least one of which is shown below with respect to FIG. 6. However, it is noted that the arrangement of windows shown on the example scenario analysis template 500 is novel in itself when implemented in accordance with the present description.

The scenario analysis template 500 includes a title bar 502, a time period selector 504 and a group selector 506. The title bar 502 indicates the subject matter of a user interface in accordance with the scenario analysis template 500. The time period selector 504 allows a user to select a time period on which to base values displayed in the user interface, e.g., a week, a month, a quarter, etc. The group selector 506 provides a way for a user to identify a particular user support services group on which to base the displayed values, such as a Group A as opposed to a Group B. When values are selected in the time period selector 504 and the group selector 506, relevant data can be retrieved for the selected group for the selected time period. Once the values are retrieved, they are displayed in the user interface.

The scenario analysis template 500 also includes a results window 508, an information window 510, a scenario calculator window 512, a comparison window 514, and a sensitivity analysis window 516. The results window 508 provides a location for displaying results of calculations made with the data received related to the selected group and for the selected time period. Results displayed in the results window 508 may include several aspects of the received data and subsequent calculations made on that data, as will be seen below, with reference to FIG. 6A and FIG. 6B. The information window 510 provides a location for displaying information related to the results window 508, such as explanatory details as to what the values in the results window 508 mean, how they can be manipulated, etc.

The scenario calculator window 512 is an area where a scenario calculator can be displayed. As will be described in greater detail, below, a scenario calculator allows a user to change individual metrics that are used in calculating results (displayed in the results window 508), and analyze how such changes will affect other metrics and/or the result. The comparison window 514 provides a location to display a comparison that tracks old values for individual metrics and new values entered by a user in a scenario calculator. The sensitivity analysis window 516 provides a location to display a sensitivity analysis graph, which shows how much a movement of a particular metric will affect a result of calculations that utilize the particular metric.

The scenario calculator window 512 further includes a tool bar 518 that is similar to tool bars shown in previous figures. The tool bar 518 can include icons for other applications that may assist a user who is working with a user interface constructed in accordance with the example scenario analysis user interface template 500.

### EXAMPLE SCENARIO ANALYSIS USER INTERFACE

One specific example of how the example scenario analysis user interface template 500 may be implemented is shown and described below with respect to FIG. 6A, which is a diagram of an example scenario analysis user interface as used in one or more tools described herein. The example scenario analysis user interface 600 shown is but one particular implementation of how the example scenario analysis UI template 500 (FIG. 5) may be used. In the following discussion of FIG. 6A, continuing reference is made to certain elements shown in FIG. 5.

The example scenario analysis user interface 600 includes a title bar 602 that displays a title related to the information displayed in the user interface 600. In this case, the title reads “Scenario Analysis.” The scenario analysis UI 600 also includes a time period selector 604 and a group selector 606. The time period selector 604 has been actuated by a user to display a time period for which data will be used to derive values displayed on the user interface 600. Particularly, the time period selector 604 has been set to “October, 2017.” The group selector 606 has been actuated by a user to identify a particular user support services team known as “Houston-Alpha.” The metrics data that will be used to derive display information will be metrics associated with the “Houston-Alpha” team for the month of October, 2017.

The example scenario analysis user interface 600 also includes a results window 608 that displays one or more results of calculations using metrics data. In the present example, the results window 608 shows a current incremental profit of “−$11,209,” an actual profit of “−$145,250,” and a profit goal of “−$134,042.” The results window 608 also shows a “new incremental profit” of “−$11,209.” A delta value is also shown that indicates that the “new” incremental profit is unchanged from the “current” incremental profit. As will be shown with FIG. 6B, these numbers will change when certain metrics in a scenario calculator change. However, for purposes of discussion, FIG. 6A does not show any changes to original calculations or displayed values.

The example scenario user interface 600 also includes an information window 610. In the present example, the information window 610 provides some explanatory comments regarding the purpose of the scenario analysis tool as well as what certain displayed information means. The example scenario user interface 600 also includes a scenario calculator window 612 which displays an interface for a scenario calculator. The scenario calculator lists a number of revenue and cost metrics particularly associated with a cellular services provider. Each metric shown a current value, a goal value, and a new value. The new value is a value that can be set by a user by making one or more changes in a “+/−” column. For example, a current CPC is shown as 3.20, with a CPC goal of 2.89. The “new” value currently shows as 3.20 because a new value has not been entered by a user. However, if a user entered a new value of 3.0, the new value would be used in computations for incremental profit and the effects of including the new value would be displayed. Using such a tool allows a user to determine how an increase or decrease in a particular metric will affect the actual and/or incremental profits.

The example scenario analysis UI 600 also includes a comparison window 614 where comparison data is displayed. In the present example, the displayed comparison data compares a current value for each metric with a new value. If a user changes a value in the scenario calculator, the comparison data will reflect that change. Also included in the example scenario UI 600 is a sensitivity analysis window 606 that displays a sensitivity analysis chart. The sensitivity analysis chart is a visualization that demonstrates the sensitivity of the incremental profit value (and the actual profit value) to each particular metric. For example, if changes are made to the deactivations metric, the changes will have a larger impact on actual profit or incremental profit values. If changes are made to the net features metric, the changes won't have as dramatic of an impact on the profit values.

The example scenario analysis UI 600 also includes a tool bar 618 that can include various icons to execute other applications. The tool bar 618 in the present example also contains an update window 620 that indicates a date or time at which the displayed information was last updated. In the present example, the update window 620 indicates that the data was last updated on “Oct. 31, 2017.”

FIG. 6B is a diagram of an example updated scenario analysis user interface 650 as used in one or more tools described herein. The user interface 650 shown in FIG. 6B is the same as the user interface 600 shown in FIG. 6A except that new values have been entered for certain metrics in the scenario calculator displayed in the scenario calculator window 612.

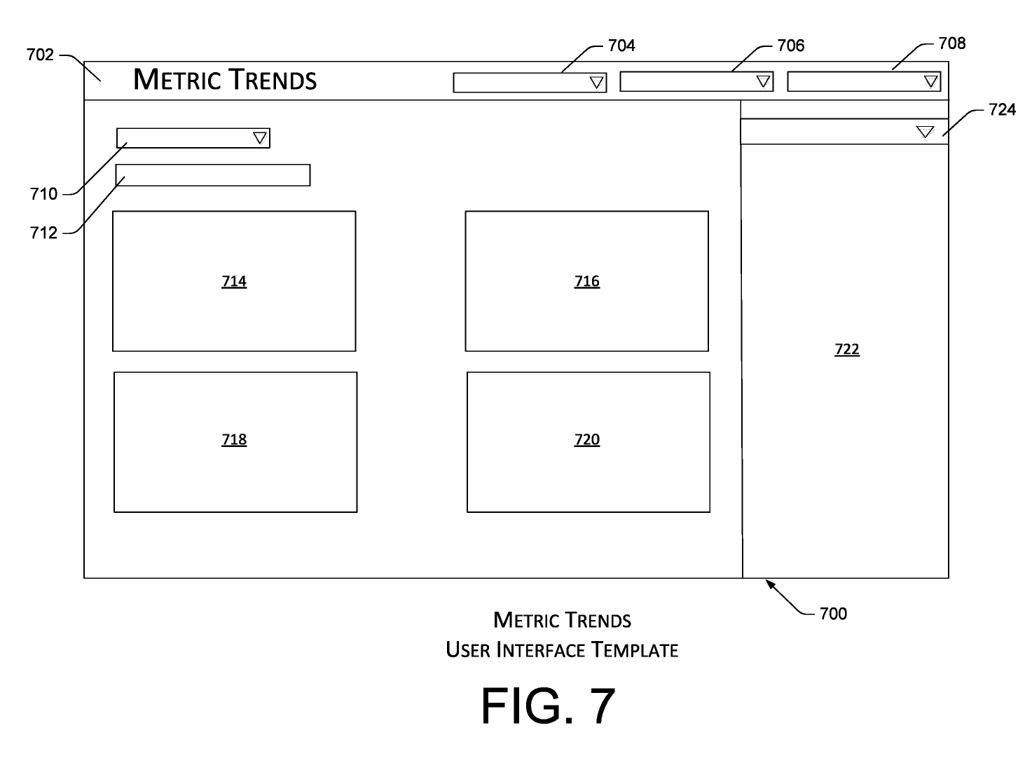

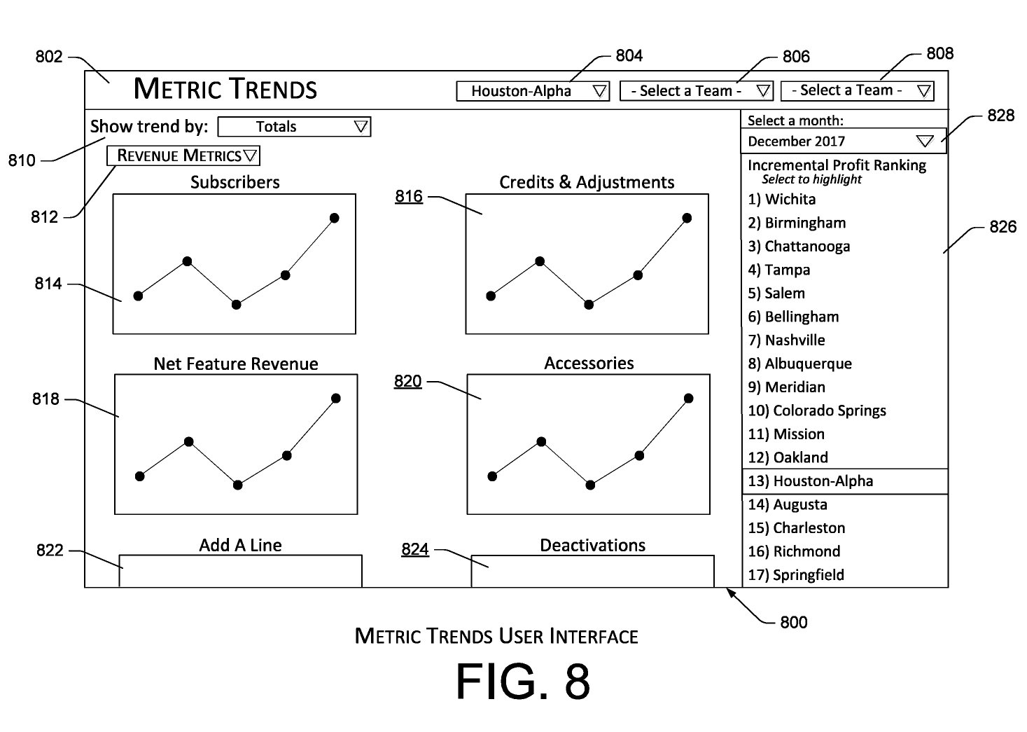

FIG. 7 is a diagram of an example metric trends user interface template 700 as used in one or more tools described herein. The example metric trends user interface template 700 (hereinafter the “example metric trends template 700”) shows generalized portions of a user interface, which may contain different types of details in different implementations, at least one of which is shown below with respect to FIG. 8. However, it is noted that the arrangement of windows shown on the example scenario analysis template 700 is novel in itself when implemented in accordance with the present description.

The example metric trends template 700 includes a title bar 702 where a title related to a user interface can be displayed. The example metric trends template 700 also includes a first group selector 704, a second group selector 706, and a third group selector 708. Although three group selectors 704, 706, 708 are shown, more or fewer group selectors may be used in one or more implementations of the techniques described herein. The user of multiple group selectors allows a user to see groups compared to each other.

The example metric trends template 700 also includes a view selector 710 and a revenue/cost selector 712. The view selector 710 allows a user to select a view of the data trends, such as by totals or . . . while the revenue/cost selector 712 allows a user to switch between revenue metrics views and cost metrics views. The example metric trends template 700 also includes several windows that are used to display data related to individual metrics. In the present example, the template 700 includes a first metric window 714, a second metric window 716, a third metric window 718, and a fourth metric window 720. Each of the windows 714-720 identifies a location where data related to a single metric can be displayed. Although only four metric windows are shown in the present example, more or fewer metric windows may be implemented. When the revenue/cost selector 712 is set to “Revenue,” the metric windows 714-720 display data related to revenue metrics. Similarly, when the revenue/cost selector 712 is set to “Cost,” the metric windows 714-720 display data related to cost metrics.

The example metric trends template 700 also includes a rankings window 722 that is used to display a list of groups, ranked according to a particular metric or overall subject, such as incremental profit. All or a portion of user support services groups are ranked in order of magnitude of the particular metric or overall subject so a user can view where a certain group stands in relation to other groups. A time period selector 724 is also included in the example metric trends template 700 whereby a user can select a particular time period to draw data for use in calculations, displays, rankings, etc.

### EXAMPLE METRIC TRENDS USER INTERFACE

One specific example of how the example metric trends user interface template 700 may be implemented is shown and described below with respect to FIG. 8, which is a diagram of an example metric trends user interface 800 as used in one or more tools described herein. The example metric trends user interface 800 shown is but one particular implementation of how the example metric trends UI template 700 (FIG. 7) may be used. In the following discussion of FIG. 8, continuing reference is made to certain elements shown in FIG. 7.

The example metric trends UI 800 includes a title bar 802 that identifies a subject matter of the UI 800, in this case, “Metric Trends.” The UI 800 also includes a first group selector 804, a second group selector 806, and a third group selector 808. Although three group selectors are shown in the present example, it is noted that there may be more or fewer group selectors. The group selectors 804, 806, 808 allow a user to select one of a plurality of user support services groups for which metric data is available. In the present example, only one group selector 804 has been actuated to reflect a particular group. In this case, the first group selector 804 indicates that metric data for the group known as “Houston-Alpha” is used in the current UI display. It is noted that if more than one group is selected, data views may be superimposed over each other to provide a comparison between the more than one groups.

The example metric trends UI 800 includes a view selector 810 that provides a way for a user to select a desired view from a list of multiple views, such as by “Totals” (as shown in the example, or by . . . A revenue/cost selector 812 is also included, and allows a user to select metrics related to revenue or metrics related to cost for display. Several metric windows are also included in the example metric trends UI 800. Since the present example shows the revenue/cost selector 812 set to “Revenue Metrics,” metric windows content is related to revenue metrics.

A first metric window 814 relates to “Subscribers” and indicates a number of subscribers. Although the indication may be made in any one of several ways, the present example is shown having a chart representing the metric data. Likewise, other metric windows also provide data views in a chart form. A second metric window 816 relates to “Credits & Adjustments.” A third metric window 818 relates to “Net Features” and a fourth metric window 820 relates to “Accessories.” A fifth metric window 822 relates to “Add A Line,” and a sixth metric window 824 relates to “Deactivations.” The fifth metric window 822 (“Add A Line”) and the sixth metric window 824 (“Deactivations”) are only partially shown. In such a situation, the user interface 800 is scrollable so that all the displayable information can be seen by a user.

The example metric trends user interface 800 also includes a group rankings window 826 that provides a display area to show a ranking of multiple user support services groups according to a metric or subject. In the present example, the groups are ranked according to incremental profit. The group selected by the first group selector 804 (i.e., “Houston-Alpha”) is highlighted in the rankings window 826. The user interface 800 also includes a time period selector 828 that allows a user to select a particular time period over which displayed data relates. In the present example, the time period selector 828 is set for “December 2017.” Therefore, revenue values for December, 2017 are reflected in the user interface 800.

### EXAMPLE METHODOLOGICAL IMPLEMENTATION

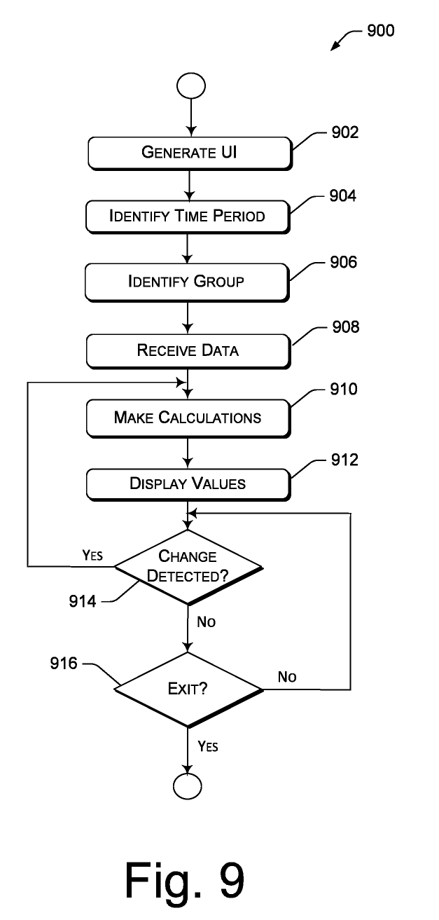

FIG. 9 is a flow diagram 900 of an example methodological implementation for a user support services tools application as used in one or more implementations described herein, and as described with regard to user support services tools 224 as shown in FIG. 2. The methodological implementation represented by the flow diagram 900 can be applied with the tools and interfaces previously described, to-wit: the profitability overview tool 226, the scenario analysis tool 228 and the trends tool 230. In the following discussion, certain operations may be attributed to one or more particular elements of a computing device (such as computing device 200, FIG. 2). However, it is noted that any operations described below may be accomplished, in whole or partially, by one or more other elements in a computing device.

At block 902, the UI generator 216 of the user support services component 214 generates an appropriate user interface, depending on whether a user has selected the overview tool 226, the scenario analysis tool 228, the trends tool 230, or some other tool. Tools may be selected from a user interface that displays all tool selections by any method known in the art, such as with a selectable menu, selectable tabs from a comprehensive tool application, etc.

At block 904, a user selection identifying a time period is received. This selection is made using a time period selector (FIG. 4, 404; FIG. 6A, 604; FIG. 8, 804) included in one of the user interfaces (FIG. 4, 400; FIG. 6A, 600; FIG. 8, 800) described herein. Selectable time periods typically include a range of days, weeks, months, quarters, or years, but a particular implementation may be configured to provide a custom time period. A user selection of a user support services group is identified at block 906. Selectable groups may include groups physically situated at local or remote locations.

At block 908, data related to the selected group for the selected time period is received. The data may be received from a remote computing device or may be retrieved from local or network storage. The received/retrieved data includes statistics related to the selected group including, but not limited to, performance statistics, revenue statistics, cost statistics, and the like. When the data is received/retrieved, the data processor 222 makes calculations to derive one or more user interface items that are displayed on the generated user interface (block 910). For example, some data can be displayed in the form it is received, such as net features revenue, deactivations, shrinkage, etc. But some UI elements, such as incremental profits, etc., are calculated from the received/retrieved data. Updated/calculated values are displayed on the user interface at block 912.

When a change in a UI value is detected (“Yes” branch, block 914), calculations are made (block 910) to update UI values, which are displayed at block 912. As previously described, a user can change values in several ways. A user can change a time period over which the UI values are calculated, or a user can change one or more groups that the user wants to analyze. Also, the scenario analysis tool allows a user to enter new values to see what affect the new values will have on other values and bottom line profitability. As long as no change is detected (“No” branch, block 914), the UI continues to be displayed. If the user makes an indication to exit a tool (“Yes” branch, block 916), then the user support services component 214 is deactivated. As long as no exit indication is received (“No” branch, block 916), the user support services component 214 continues to be active.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A system, comprising:
one or more processors;
memory;
a user support services tool configured to:
receive a user selection of a time period;
receive a user selection of a user support services group;
access user support services metrics for the selected group over the selected time period;
calculate one or more performance values from the user support services metrics;
receive similar performance values for one or more user support services groups other than the selected user support services group; and
display the performance values for the selected user support services group as compared to the performance values for the user support services group other than the selected user support services group.

2. The system as recited in claim 1, wherein the user support services tool is further configured to receive a user selection of the one or more support services group other than the selected user support services group.

3. The system as recited in claim 1, wherein the user support services tool is further configured to:
receive user input to change at least one user support services metric;
re-calculate the displayed performance value from the user support services metrics, including the changed metric; and
display the performance values for the user support services groups, including performance values updated as a result of the change to the user support services metric.

4. The system as recited in claim 1, wherein the metrics further include metrics related to at least one of the following group of metrics: performance metrics, revenue metrics, cost metrics.

5. The system as recited in claim 1, wherein at least one performance value is a profit value.

6. The system as recited in claim 1, wherein at least one performance value is an incremental profit value.

7. A method, comprising:
generating a user interface for a user support services tool;
identifying a time period received by way of a user interface selection;
identifying a first user support services group by way of a user interface selection;
receiving metrics data related to the first user support services group over the selected time period;
calculating one or more performance values from the received metrics data;
displaying the one or more performance values together with at least a portion of the received metrics data;
receiving an updated value for at least one metric;
calculating an updated performance value from the received metrics data, including the updated value for the at least one metric; and
displaying the one or more updated performance values together with at least a portion of the received metrics data.

8. The method as recited in claim 7, further comprising:
receiving metrics data for a second user support services group;
calculating the one or more performance values for the second user support services group; and
displaying the one or more performance values for the second user support services group together with the one or more performance values for the first user support services group so that the performance values can be compared.

9. The method as recited in claim 7, further comprising:
receiving the one or more performance values for the second user support services group; and
displaying the one or more performance values for the second user support services group together with the one or more performance values for the first user support services group so that the performance values can be compared.

10. The method as recited in claim 7, wherein the performance values include at least a profit value.

11. The method as recited in claim 7, wherein the performance values include at least an incremental profit value.

12. The method as recited in claim 7, further comprising:
displaying a first individual metric related to a first user support services group in a first user interface window; and
displaying a second individual metric related to the first user support services group in a second user interface window.

13. The method as recited in claim 12, wherein the first individual metric and the second individual metric relate to a first user support group, and further comprising:
displaying a first individual metric related to a second user support services group in the first user interface window; and
displaying a second individual metric related to the second user support services group in the second user interface window.

14. The method as recited in claim 13, wherein the individual metrics are displayed in the respective user interface windows in the form of a chart identifying a trend of the individual metric over time.

15. One or more tangible computer-readable media storing computer-executable instructions that, when executed, perform the following operations:
receiving a selection of a first user support services group;
receiving a selection of a time period;
receiving performance metrics data related to a first group for the selected time period;
calculating a profitability value from at least a portion of the performance metrics data;
receiving performance metrics data related to a second user support services group;
displaying a user interface that displays at least a portion of the performance metrics data and the profitability value related to the first user support services group, and at least a portion of the performance metrics data related to the second user support services group;
detecting a user selection via the user interface;
recalculating the profitability value from values changed as a result of the user selection; and
displaying the user interface with the recalculated profitability value.

16. The one or more computer-readable media as recited in claim 15, wherein the detecting a user selection via the user interface further comprising detecting a change in the selected time period.

17. The one or more computer-readable media as recited in claim 15, wherein the detecting a user selection via the user interface further comprising detecting a change in the selected first user support services group.

18. The one or more computer-readable media as recited in claim 15, wherein the detecting a user selection via the user interface further comprising detecting a change in at least one performance metric value.

19. The one or more computer-readable media as recited in claim 15, wherein the user interface further comprises:
a first metric window that displays a first individual performance metric for the first user support services group and for a second user support services group; and
a second metric window that displays a second individual performance metric for the first user support services group and the second user support services group.

20. The one or more computer-executable media as recited in claim 19, wherein the individual performance metrics displayed in the metric windows are displayed in the form of a chart that shows a change in the individual performance metrics over time.
